(19) United States
(12) Patent Application Publication
(10) Pub. No.: US 2024/0240660 A1
(43) Pub. Date: Jul. 18, 2024

(54) Ergonomic Fastener for Quick Attachment

(71) Applicant: Illinois Tool Works Inc., Glenview, IL (US)

(72) Inventors: Chad M. Clark, Stamping Ground, KY (US); Mark A. Beyer, Troy, MI (US)

(21) Appl. No.: 18/404,689

(22) Filed: Jan. 4, 2024

Related U.S. Application Data
(60) Provisional application No. 63/439,352, filed on Jan. 17, 2023.

(51) Int. Cl. F16B 5/02

(52) U.S. Cl. CPC F16B 5/0258; F16B 5/0208

(57) ABSTRACT

Described is a stamped-metal ergonomic retainer clip for attaching a first component having a first opening relative to a second component having a second opening. The retainer clip having a first planar portion and a second planar portion, fastener plate, and a guide lip. The first planar portion and the second planar portion are resiliently connected via a bend to define a channel. The fastener plate is resiliently connected to the first planar portion and extends into the channel and configured to couple with the male fastener, while the second planar portion defines a fastener hole to receive the shank. The channel is configured to receive and secure the first component between the fastener plate and the second planar portion. The guide lip is positioned adjacent an opening to the channel and is configured to guide the first component into the channel and to provide a bearing area for manipulation during assembly.

### RELATED APPLICATIONS

The present application claims priority to U.S. Provisional Patent Application No. 63/439,352, filed Jan. 17, 2023, and entitled “Ergonomic Fastener for Quick Attachment,” which is hereby incorporated by reference in its entirety.

### BACKGROUND

Automotive components require fastening techniques that are simple to manufacture and assemble. Further, fastening techniques should above all be reliable and efficient.

In some examples, components are assembled at least partially by hand on, for example, an assembly line. Incorporating ergonomic principles into the design of an assembly line promotes worker safety, enhances productivity, and fosters a positive work environment, which not only benefits the employees, but also contributes to the overall success and sustainability of the manufacturing process.

Therefore, despite advancements to date, it would be highly desirable to provide ergonomic solutions for quickly attaching a fastener to a panel.

### SUMMARY

The present disclosure relates generally to an ergonomic fastener to form a connection between two components, such as vehicular components, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an isometric assembly view of an ergonomic fastener assembly in accordance with an aspect of this disclosure.

FIGS. 1b and 1c illustrate isometric views of the fastening system during different stages of assembly.

FIG. 2a illustrates a topside isometric view of the retainer clip of FIGS. 1a through 1c.

FIGS. 2b and 2c illustrate side elevation views of the retainer clip.

FIG. 2d illustrates a top plan view of the retainer clip.

FIG. 2e illustrates a bottom plan view of the retainer clip.

FIG. 2f illustrates a front elevation view of the retainer clip.

FIG. 2g illustrates a rear elevation view of the retainer clip.

FIG. 2h illustrates an isometric view of the ergonomic fastener assembly.

FIG. 2i illustrates a cross-sectional side view of the ergonomic fastener assembly taken along cut line A-A (FIG. 2h).

FIG. 3 illustrates a cross-sectional side view of the ergonomic fastener assembly having a shoulder bolt taken along cut line A-A (FIG. 2h).

FIGS. 4a through 4c illustrate isometric views of the fastening system in accordance with another aspect of this disclosure during different stages of assembly.

FIG. 5a illustrates a topside isometric view of the retainer clip of FIGS. 4a through 4c.

FIGS. 5b and 5c illustrate side elevation views of the retainer clip.

FIG. 5d illustrates a top plan view of the retainer clip.

FIG. 5e illustrates a bottom plan view of the retainer clip.

FIG. 5f illustrates a front elevation view of the retainer clip.

FIG. 5g illustrates a rear elevation view of the retainer clip.

FIG. 6a illustrates a topside isometric view of a retainer clip in accordance with yet another aspect of this disclosure.

FIGS. 6b and 6c illustrate side elevation views of the retainer clip.

FIG. 6d illustrates a top plan view of the retainer clip.

FIG. 6e illustrates a bottom plan view of the retainer clip.

FIG. 6f illustrates a front elevation view of the retainer clip.

FIG. 6g illustrates a rear elevation view of the retainer clip.

FIG. 7a illustrates a topside isometric view of a retainer clip in accordance with yet another aspect of this disclosure.

FIGS. 7b and 7c illustrate side elevation views of the retainer clip.

FIG. 7d illustrates a top plan view of the retainer clip.

FIG. 7e illustrates a bottom plan view of the retainer clip.

FIG. 7f illustrates a front elevation view of the retainer clip.

FIG. 7g illustrates a rear elevation view of the retainer clip.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed are ergonomic solutions for quickly and efficiently joining components via a fastener assembly. The disclosed fastener assemblies employ retainer clips that provide a large bearing area for resting the thumb on during hand insertion, while also defining a shape that allows for a large panel thickness range and minimal installation force for ergonomics. The retainer clips further employ interlocking tabs near an edge to provide maximum torque resistance while still allowing flexibility for installation. The shape of the disclosed retainer clips provides maximum bearing area with minimal insertion force for improved ergonomics while providing high torque performance. In addition, whereas traditional retainer clip designs with clinched in studs are prone to failing under torque, the disclosed retainer clip employs a locking head concept to mitigate that issue.

In one example, an ergonomic retainer clip for attaching a first component having a first opening relative to a second component having a second opening comprises: a first planar portion and a second planar portion that are resiliently connected via a bend to define a channel, wherein the second planar portion defines a fastener hole to receive a shank of a male fastener; a fastener plate resiliently connected to the first planar portion and extending into the channel, wherein the fastener plate is configured to couple with the male fastener, and wherein the channel is configured to receive and secure the first component between the fastener plate and the second planar portion; a guide lip positioned adjacent an opening to the channel and configured to guide the first component into the channel and to provide a bearing area for manipulation during assembly; and a plurality of interlocking tabs configured to mitigate movement of the fastener plate relative to the first planar portion and the second planar portion.

In another example, an ergonomic fastener assembly for attaching a first component having a first opening relative to a second component having a second opening comprises: a male fastener having a head and a shank; and a retainer clip having a first planar portion and a second planar portion, fastener plate, and a guide lip, wherein the first planar portion and the second planar portion are resiliently connected via a bend to define a channel, wherein the fastener plate is resiliently connected to the first planar portion and extends into the channel and configured to couple with the male fastener, while the second planar portion defines a fastener hole to receive the shank, wherein the channel is configured to receive and secure the first component between the fastener plate and the second planar portion, and wherein the guide lip is positioned adjacent an opening to the channel and is configured to guide the first component into the channel and to provide a bearing area for manipulation during assembly.

In yet another example, a stamped-metal ergonomic retainer clip for attaching a first component having a first opening relative to a second component having a second opening comprises: a first planar portion and a second planar portion that are resiliently connected via a bend to define a channel, wherein the second planar portion defines a fastener hole to receive a shank of a male fastener; a fastener plate resiliently connected to the first planar portion and extending into the channel, wherein the fastener plate defines a collar with an internally-threaded bore that is configured to engage the shank of the male fastener, and wherein the channel is configured to receive and secure the first component between the fastener plate and the second planar portion; and a guide lip positioned adjacent an opening to the channel and configured to guide the first component into the channel and to provide a bearing area for manipulation during assembly.

In some examples, the guide lip coupled to the first planar portion.

In some examples, the fastener plate defines a head recess sized and shaped to receive a head of a male fastener. The fastener plate can further comprise one or more retention features positioned at a perimeter of the head recess to retain and mitigate rotation of the male fastener relative to the fastener plate. Each of the one or more retention features may comprise a retainer tab configured to retain the male fastener and a wall portion configured to mitigate rotation of the male fastener.

In some examples, the fastener plate defines a collar with an internally-threaded bore that is configured to engage the shank of the male fastener.

In some examples, the second planar portion comprises one or more panel tabs configured to secure the ergonomic retainer clip to the first component via an interference fit at the first opening.

In some examples, the ergonomic retainer clip is a stamped-metal component.

In some examples, the plurality of interlocking tabs comprises a set of first interlocking tabs coupled to the fastener plate interleaved with a second interlocking tab formed at the bend.

In some examples, the second interlocking tab is formed at the bend adjacent the first planar portion or the second planar portion.

In some examples, the set of first interlocking tabs is perpendicular to the second interlocking tab.

In some examples, one of the one or more panel tabs is positioned in the fastener hole and configured to encircle the shank when assembled.

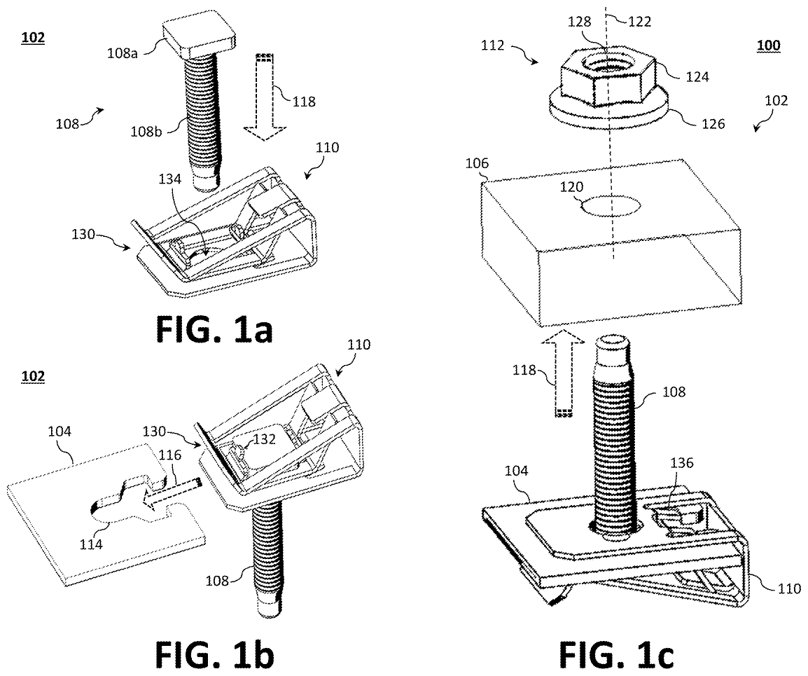

FIG. 1a illustrates an isometric assembly view of an ergonomic fastener assembly 102 in accordance with an aspect of this disclosure, while FIGS. 1b and 1c illustrate isometric views of the fastening system 100 during different stages of assembly. The illustrated fastening system 100 includes the first component 104, the second component 106, and an ergonomic fastener assembly 102. The ergonomic fastener assembly 102 is configured to join the first component 104 and the second component 106, while improving ergonomics during assembly.

To facilitate attachment via the ergonomic fastener assembly 102, each of the first component 104 and the second component 106 includes one or more engagement features. For example, the first component 104 is illustrated as having a first opening 114 formed therein and the second component 106 is illustrated as having a second opening 120 formed therein. In the illustrated example, the first opening 114 is shaped to receive and engage the retainer clip 110, while the second opening 120 is circular and sized and shaped to receive a portion of the male fastener 108.

The first opening 114 and the second opening 120 can be formed in the respective first component 104 or second component 106 during manufacturing thereof or added post-manufacture through a mechanical process (e.g., drilling, cutting, carving, etc.). After the first component 104 and the second component 106 are assembled, as best illustrated in FIG. 1c, the second component 106 is covered at least partially by the first component 104.

The ergonomic fastener assembly 102 is illustrated as a multi-component ergonomic fastener assembly 102 having a male fastener 108 (e.g., an externally-threaded shaft, such as a bolt), a retainer clip 110 (e.g., a metal retainer clip), and, in some cases, a female fastener 112 (e.g., an internally-threaded component, such as a nut). As will be described in connection with other examples, the function of the female fastener 112 can be integrated with the retainer clip 110. The retainer clip 110 serves to mechanically engage and couple with the first component 104 via the first opening 114, while the male fastener 108 and the female fastener 112 serves to couple the first component (via the retainer clip 110) to the second component 106 (via its second opening 120).

It is contemplated that certain components of the multi-component ergonomic fastener assembly 102 may be fabricated as a stamped-metal component using a metal-stamping technique. For example, the retainer clip 110 can be fabricated from a single sheet of metal and stamped/bent using a metal-stamping technique, while the male fastener 108 and the female fastener 112 can be fabricated from metal via one or more metal-shaping techniques, such as cold forging. In another example, the retainer clip 110 can be fabricated as a stamped-metal component, whereas the male fastener 108 and the female fastener 112 can be fabricated from a plastic material using a plastic injection technique, additive manufacturing, or otherwise. In some examples, one or more components of the ergonomic fastener assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

The first component 104 and the second component 106 may be, for example, automotive panels or other automotive components. Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 104 include, without limitation, door trim panels, moldings, trim pieces, and other substrates (whether used as interior or exterior surfaces). The second component 106 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

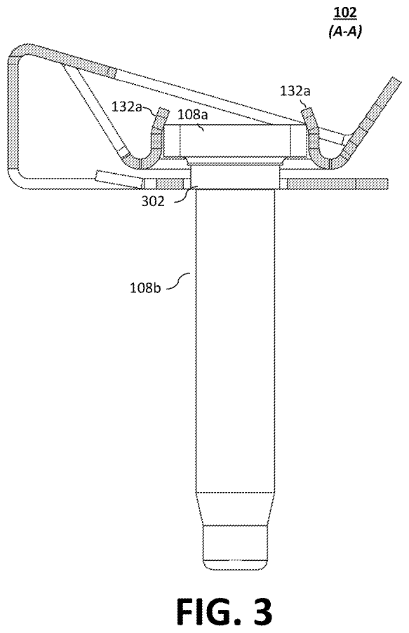

The retainer clip 110 can be sub-assembled with a male fastener 108 before being pressed onto a first component 104. As illustrated, the male fastener 108 comprises a head 108a and a shank 108b. In the illustrated example, the head 108a is square and the shank 108b is threaded. While the male fastener 108 is illustrated a threaded bolt having a head 108a that is square, other types of fasteners are contemplated. For example, a shoulder bolt is used in the example illustrated in FIG. 3.

During installation, as best illustrated in FIGS. 1a through 1c, an end of the shank 108b is passed through the fastener hole 134 formed in the retainer clip 110 as indicated by arrow 118. The male fastener 108 can be retained relative to the retainer clip 110 via one or more retention features 132. The retainer clip 110 and the male fastener 108 is then slid onto the first component 104 and into the first opening 114 of the first component 104 via a channel 130 as indicated by arrow 116 and retained by, for example, panel tabs 136. As noted, the first opening 114 is sized and shaped to receive and retain the retainer clip 110. In the illustrated example, the first opening 114 is generally rectangular and a portion of the first component 104 is sandwiched between the legs of the retainer clip 110 (e.g., along at least a portion of its perimeter) such that a fastener hole formed in the retainer clip 110 aligns with a second opening 120 formed in the second component 106.

Once the retainer clip 110 is installed, an end of the shank 108b of the male fastener 108 is passed through the second opening 120 of the second component 106 as indicated by arrow 118 to ultimately engage the female fastener 112. The male fastener 108 and/or the female fastener 112 can be rotated relative to one another about its axis of rotation 122 to join and compress the first component 104 and second component 106 relative to one another. In this example, the male fastener 108 is rotationally fixed relative to the retainer clip 110. As will be described in greater detail, the ergonomic fastener assembly 102 includes one or more features to rotationally fix and secure the male fastener 108, thus mitigating risk of loss of the male fastener 108.

In some examples, the ergonomic fastener assembly 102 comprises a seal when desirable to mitigate dust, dirt, and/or moisture penetration through the second opening 120, for example. The seal may be embodied as a ring (e.g., an annulus) and fabricated from foam material, thermoplastic, rubber, etc. For example, a seal can be configured to surround a portion of the male fastener 108 (e.g., the shank) and positioned between the second component 106 and female fastener 112.

The female fastener 112 can comprise a head 124, a flange 126, and an internally-threaded bore 128 configured to threadedly engage the shank 108b. The head 124 can be hex-shaped to facilitate tool engagement, while the flange 126 serves to increase the contact surface area between the head 124 and the second component 106. As noted below, in some examples, a seal can be positioned around the shank 108b between the flange 126 and the second component 106 to form a liquid or gas barrier. FIG. 1c illustrates the female fastener 112 in the form of a one-piece flange nut. While a one-piece female fastener 112 is illustrated, in other examples, the female fastener 112 can be a multi-component piece.

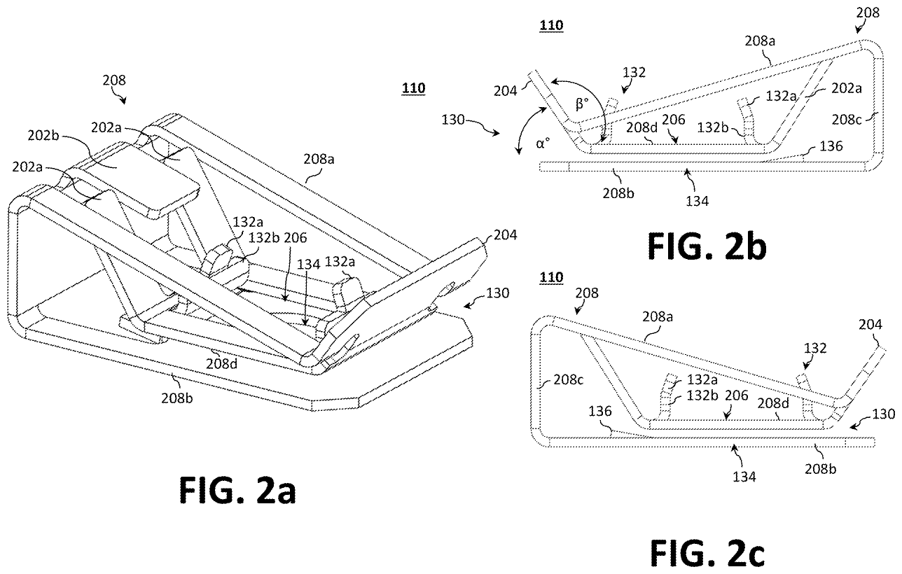

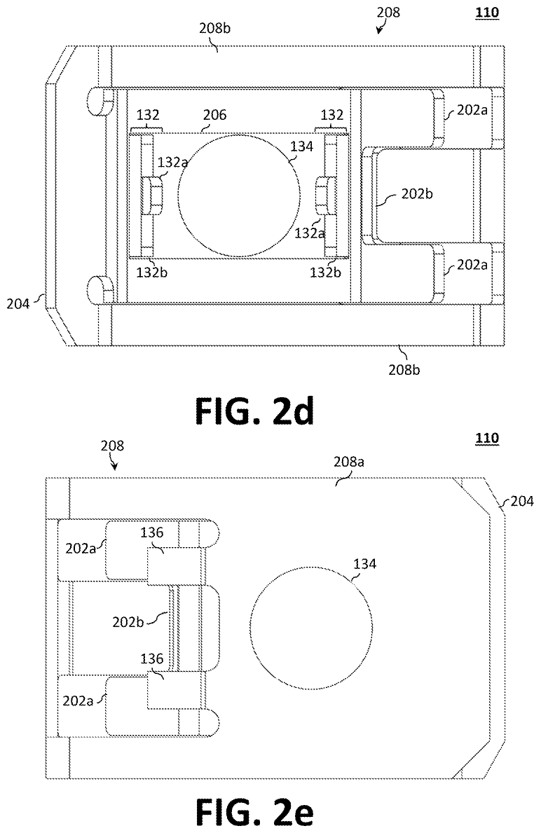

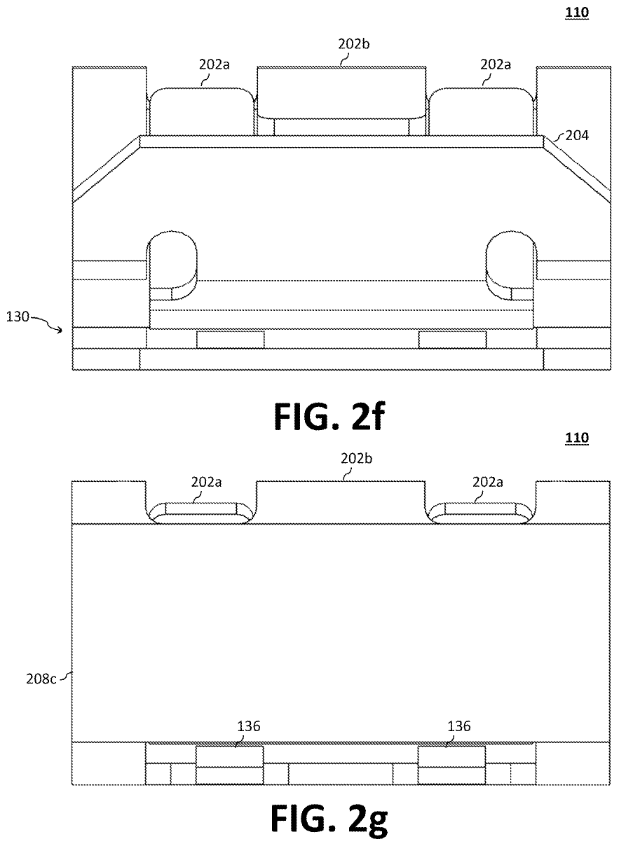

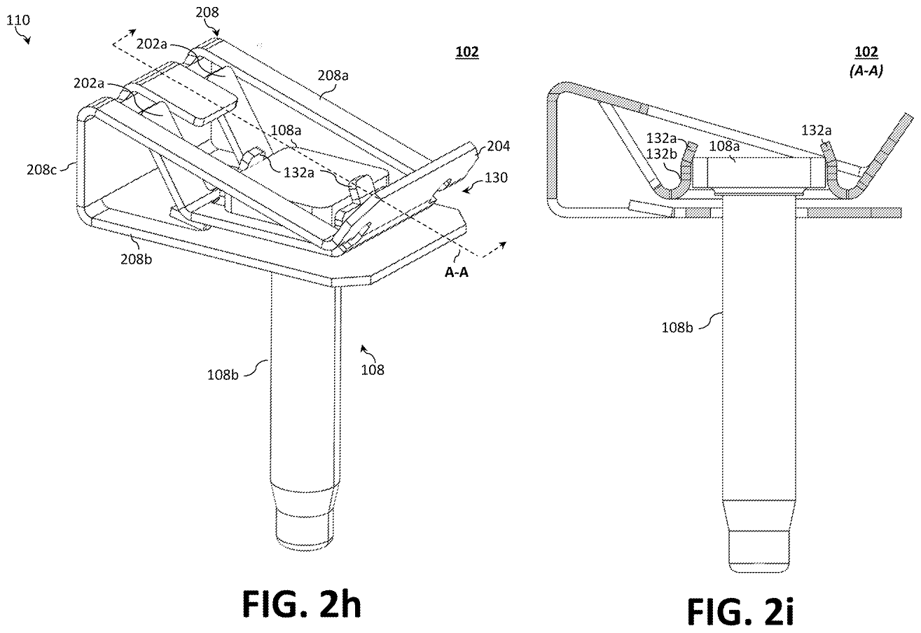

FIG. 2a illustrates a topside isometric view of the retainer clip 110 of FIGS. 1a through 1c. FIGS. 2b and 2c illustrate side elevation views of the retainer clip 110, while FIGS. 2d and 2e illustrate, respectively, top and bottom plan views of the retainer clip 110. FIGS. 2f and 2g illustrate, respectively, front and rear elevation views of the retainer clip 110. FIG. 2h illustrates an isometric view of the ergonomic fastener assembly 102, while FIG. 2i illustrates a cross-sectional side view thereof taken along cut line A-A (FIG. 2h).

The illustrated retainer clip 110 comprises a body portion 208 that defines a channel 130 (e.g., a U-shaped channel) to receive the first component 104. The illustrated body portion 208 is formed as a pair of first and second planar portions 208a, 208b that are resiliently connected at an end via a bend 208c (e.g., a spring clip). As illustrated, the first and second planar portions 208a, 208b are generally flat and the bend 208c provides a shape that allows for a large panel thickness range and minimal installation force for ergonomics. The pair of opposing first and second planar portions 208a, 208b are resiliently connected at the bend 208c such that the pair of opposing first and second planar portions 208a, 208b default (e.g., spring back) to a predetermined shape. The channel 130 is sized to slide onto and receive a least a portion of the first component 104 (e.g., at the perimeter of the first opening 114). In the illustrated example, the second planar portion 208b defines the fastener hole 134.

The illustrated first planar portion 208a is stamped and bent to form a fastener plate 208d that is resiliently connected to the first planar portion 208a at one end adjacent a guide lip 204 at an opening to the channel 130. As illustrated, the fastener plate 208d can be punched from the first planar portion 208a and bent to extend into the channel 130. While the first and second planar portions 208a, 208b are non-parallel, the fastener plate 208d is generally parallel to the second planar portion 208b and configured to sandwich the first component 104 therebetween. As illustrated, the guide lip 204 can be shaped at an angle to guide the first component into the channel 130 during assembly. In addition, the guide lip 204 provides a bearing area for manipulation during assembly by an operator. For example, the guide lip 204 is sized to provide a large bearing area for resting the thumb during hand insertion or assembly, thus improving ergonomics for the operator.

The angle (α) defined between the guide lip 204 and the second planar portion 208b is, for example, less than 90 degrees, between about 30 and 70 degrees, or between about 50 and 60 degrees (as illustrated). The angle (β) defined between the guide lip 204 and fastener plate 208d is the supplementary angle. To achieve the angle (α), the guide lip 204 is bent relative to the first planar portion 208a

The fastener plate 208d defines a head recess 206, which can be shaped to correspond to the shape of the head 108a of the male fastener 108. In the illustrated example, the male fastener 108 is a threaded bolt with a square head 108a and the head recess 206 has a corresponding square perimeter. When assembled, the square head 108a resides within the head recess 206 and is prevented from rotating about its axis of rotation 122 via, inter alia, the sidewalls of the head recess 206.

The retainer clip 110 further comprises one or more retention features 132 at the fastener plate 208d to retain and rotationally fix the male fastener 108 by capturing the head 108a. The one or more retention features 132 can be positioned at the perimeter of the head recess 206. The head 108a can snap through retention features 132 in the retainer clip 110, or a portion of the retention features 132 can be bent over the top of the head 108a to lock it into place.

In the illustrated example, the fastener plate 208d includes two retention feature 132 (one on each side of the head recess 206); each of the retention features 132 includes a retainer tab 132a and a wall portion 132b. The retainer tab 132a retains the male fastener 108 within the head recess 206 prior to assembly (e.g., can be bent over the head 108a), thus enabling the retainer clip 110 and male fastener 108 to be packaged as a part-in-assembly (PIA), thus reducing time and effort needed during assembly by an end-user. The wall portion 132b abuts or otherwise rests against a surface of the head 108a (e.g., a straight edge) to provide resistance to torque during assembly with the female fastener 112.

The body portion 208 can further comprise one or more panel tabs 136 and one or more sets of interlocking tabs 202a, 202b. The illustrated panel tabs 136 are formed in or on the second planar portion 208b (e.g., the flat side) of the retainer clip 110 and are configured to snap into a feature on the first component 104 creating audible/tactile feedback during installation onto the first component 104. The one or more panel tabs 136 secure the retainer clip 110 to the first component 104 via an interference fit. As illustrated in FIG. 1c, each of the one or more panel tabs 136 extends into the first opening 114.

This interlocking tabs 202a, 202b provides minimal installation force with maximum bearing area and torque resistance. In the illustrated example, the set of first interlocking tabs 202a is coupled to the fastener plate 208d and a second interlocking tab 202b is formed at the bend 208c adjacent the first planar portion 208a. As best illustrated in FIG. 2a, the interlocking tabs 202a, 202b interleave to mitigate side-to-side movement of the fastener plate 208d relative to the remainder of the body portion 208 when, for example, the male fastener 108 and female fastener 112 are torqued about the axis of rotation 122.

The various features of the retainer clip 110 (e.g., head recess 206, retention features 132, interlocking tabs 202a, 202b, etc.) can be stamped and/or punched from the material of the body portion 208 and bent to shape.

FIG. 3 illustrates a cross-sectional side view of the ergonomic fastener assembly 102 having a shoulder bolt taken along cut line A-A (FIG. 2h). The ergonomic fastener assembly 102 of FIG. 3 is substantially the same as that of FIGS. 2a through 2i, except the male fastener 108 is a shoulder bolt for compression limiting the first component 104. A shoulder bolt, also known as a shoulder screw or stripper bolt, includes a shoulder 302 between the head 108a and the threaded shank 108b.

As illustrated, the male fastener 108 comprises a head 108a and a shank 108b with a shoulder 302 adjacent the head 108a. The shoulder 302 is a cylindrical, unthreaded section, which serves as a spacer to facilitate compression limiting. An advantage of using a shoulder bolt is that shoulder 302 eliminates a need for a separate limiter component in the ergonomic fastener assembly 102. In the illustrated example, the head 108a is square and the portion of the shank 108b beyond the shoulder 302 is threaded. When assembled, the shank 108b (and the shoulder 302) pass at least partially through the fastener hole 134 and the second opening 120. The shoulder 302 limits compression imparted on the second component 106 via the female fastener 112. More specifically, the diameter of the shoulder 302 is greater than the diameter of the shank 108b such that the female fastener 112 is prevented from further compressing upon contact with the shoulder 302, thus maintaining a distance that generally corresponds to the thickness of the second component 106.

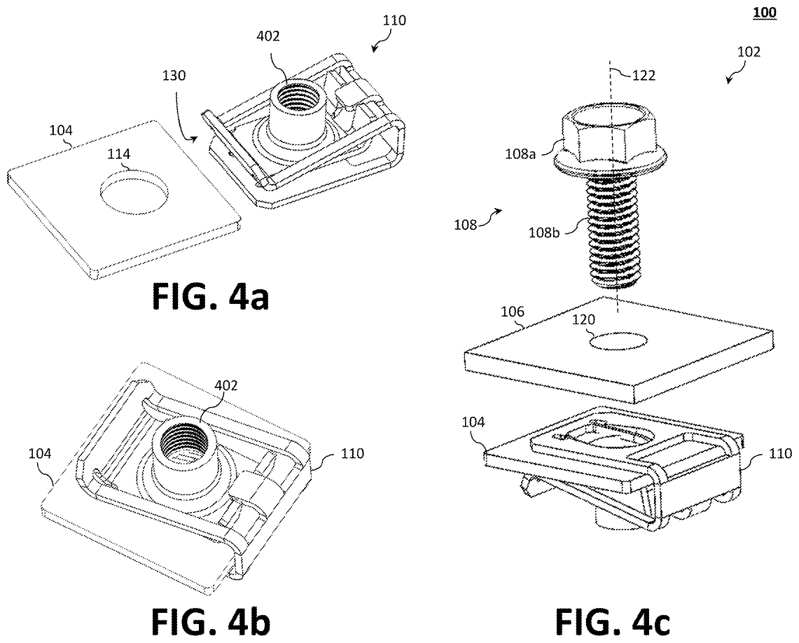

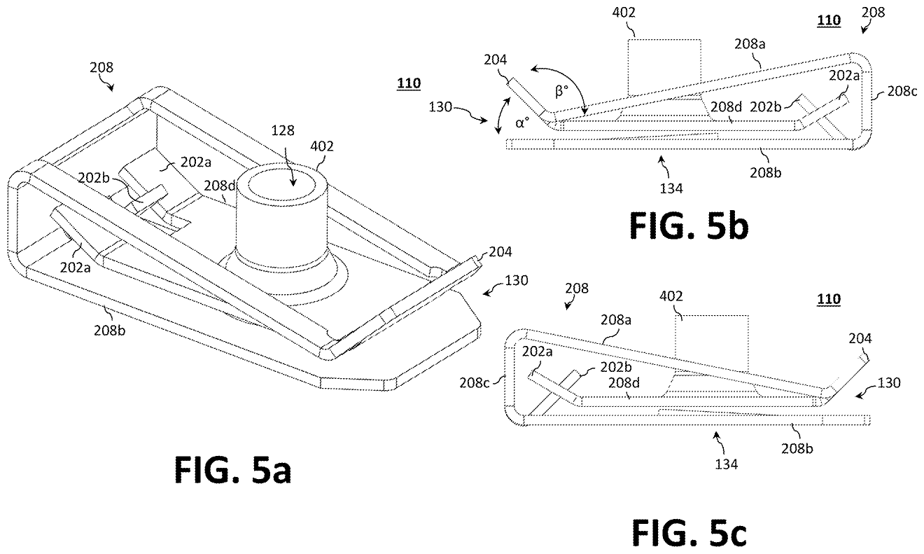

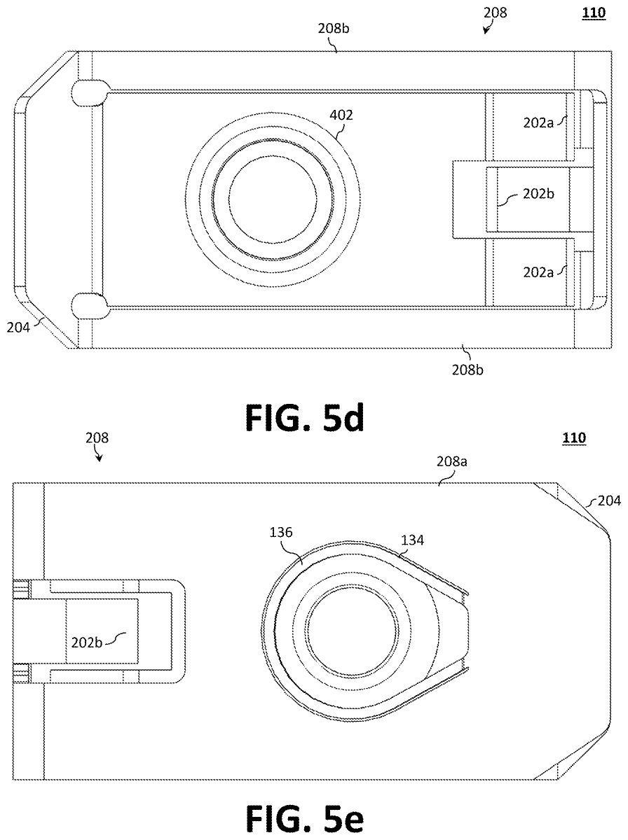

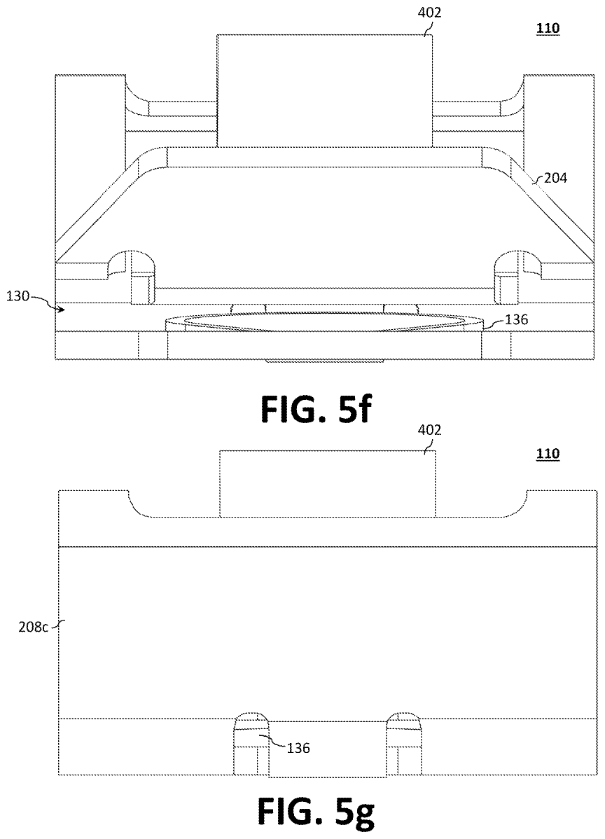

FIGS. 4a through 4c illustrate isometric views of the fastening system 100 in accordance with another aspect of this disclosure during different stages of assembly, while FIG. 5a illustrates a topside isometric view of the retainer clip 110 of FIGS. 4a through 4c. FIGS. 5b and 5c illustrate side elevation views of the retainer clip 110, while FIGS. 5d and 5e illustrate, respectively, top and bottom plan views of the retainer clip 110. FIGS. 5f and 5g illustrate, respectively, front and rear elevation views of the retainer clip 110. The ergonomic fastener assembly 102 of FIGS. 4a through 4c and FIG. 5a through 5g is similar to that of FIGS. 1a through 1j and FIGS. 2a through 2i except that the ergonomic fastener assembly 102 of FIGS. 4a through 4c and FIG. 5a through 5g obviates the need for a separate female fastener 112 by integrating an internally-threaded collar 402 into the retain clip 110.

As illustrated, the fastener plate 208d defines a collar 402 having the internally-threaded bore 128. The internally-threaded bore 128 is configured to threadedly engage the shank 108b of the male fastener 108. In this example, the male fastener 108 comprises a flange and a head 108a that is hex-shaped to facilitate tool engagement. The flange serves to increase the contact surface area between the head 108a and the second component 106. Thus, whereas the previously-described retainer clip 110 retains the head 108a via the fastener plate 208d, this retainer clip is configured to threadedly engage the shank 108b.

In this example, the panel tabs 136 positioned on the second planar portion 208b of the retainer clip 110 are generally U-shaped and configured to snap into a first opening 114 on the first component 104, thus providing audible/tactile feedback during installation onto the first component 104. In the illustrated example, the panel tab 136 is positioned in the fastener hole 134 (e.g., formed along the inner perimeter for the fastener hole 134) and generally U-shaped to at least partially encircle or surround the shank 108b when assembled.

As with the prior example, the interlocking tabs 202a, 202b are shaped and configured to provide minimal installation force with maximum bearing area and torque resistance. In the illustrated example, the angle (α) defined between the guide lip 204 and the second planar portion 208b is about 45 degrees.

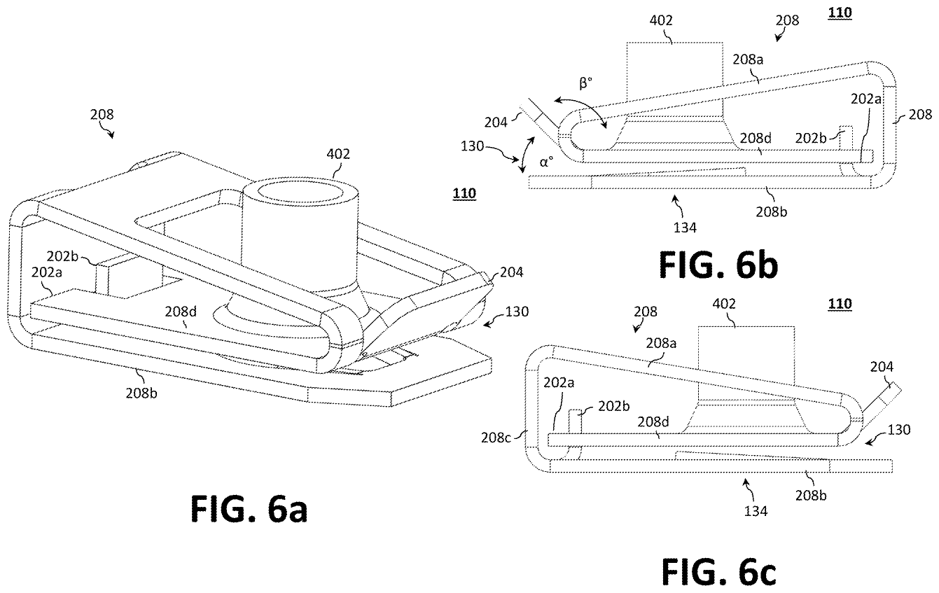

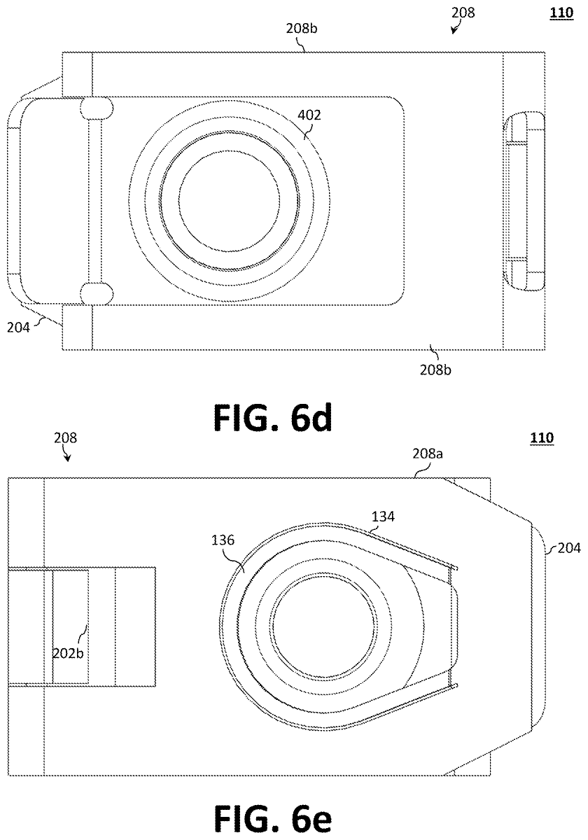

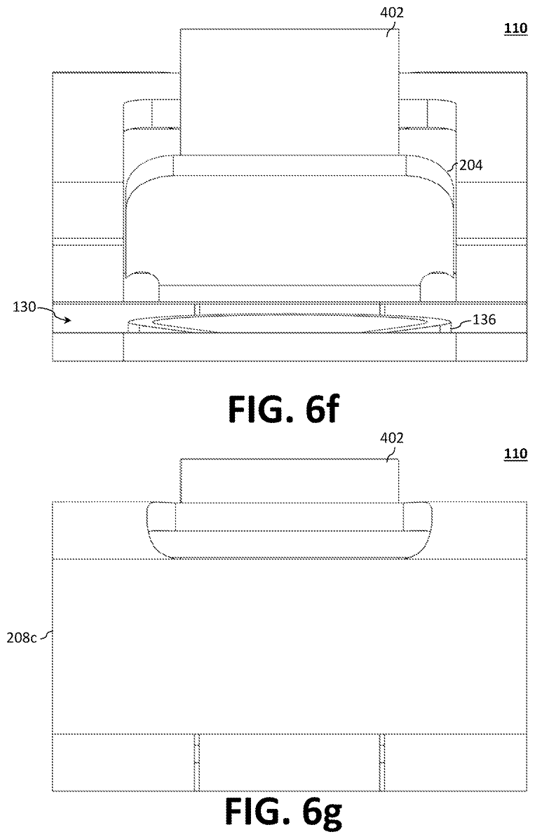

FIG. 6a illustrates a topside isometric view of a retainer clip 110 in accordance with yet another aspect of this disclosure. FIGS. 6b and 6c illustrate side elevation views of the retainer clip 110, while FIGS. 6d and 6e illustrate, respectively, top and bottom plan views of the retainer clip 110. FIGS. 6f and 6g illustrate, respectively, front and rear elevation views of the retainer clip 110. The retainer clip 110 of FIG. 6a through 6g is substantially similar to that of FIGS. 5a through 5g except for the configuration of the interlocking tabs 202a, 202b.

In the illustrated example, the set of first interlocking tabs 202a is coupled to the fastener plate 208d and a second interlocking tab 202b is formed at the bend 208c adjacent the second planar portion 208b. As illustrated, the second interlocking tab 202b is generally perpendicular to the second planar portion 208b and to the fastener plate 208d. As a result, the set of first interlocking tabs 202a and the second interlocking tab 202b are perpendicular to one another.

Positioning the second interlocking tab 202b adjacent the second planar portion 208b obviates the need to bend the first interlocking tabs 202a to form an angle. Thus, in this example, the first interlocking tabs 202a are planar with the fastener plate 208d. More specifically, in this example, the fastener plate 208d is punched to define the set of interlocking tabs 202a with a space therebetween to receive the second interlocking tab 202b. In the illustrated example, the angle (α) defined between the guide lip 204 and the second planar portion 208b is about 45 degrees.

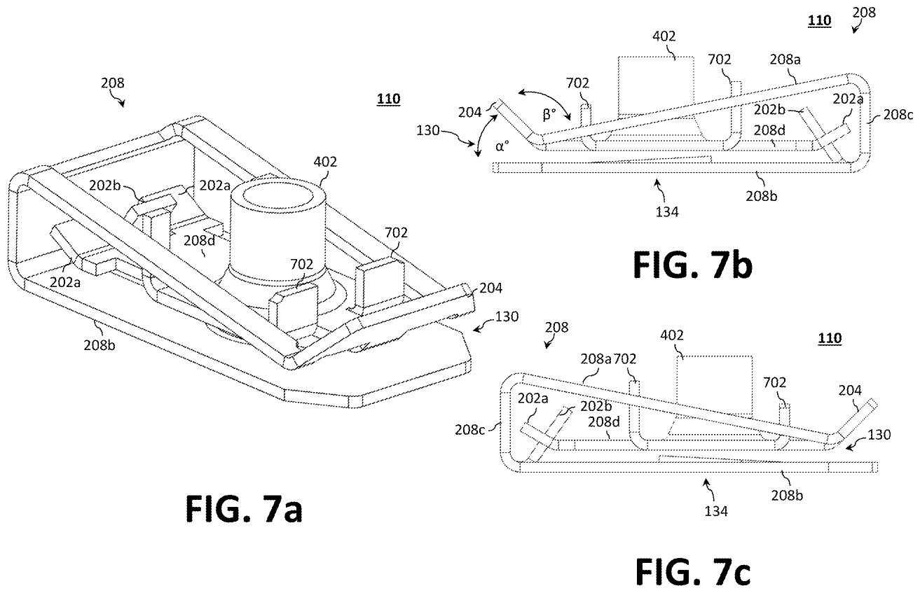

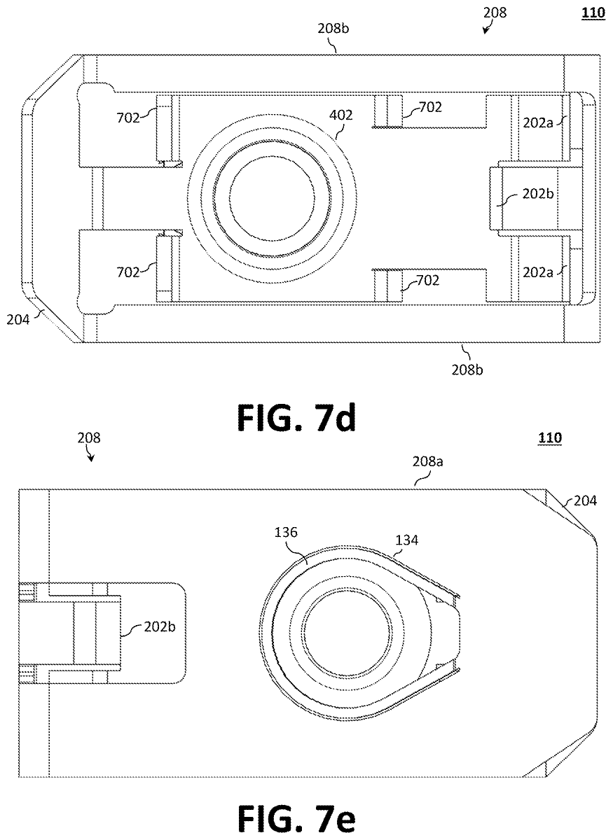

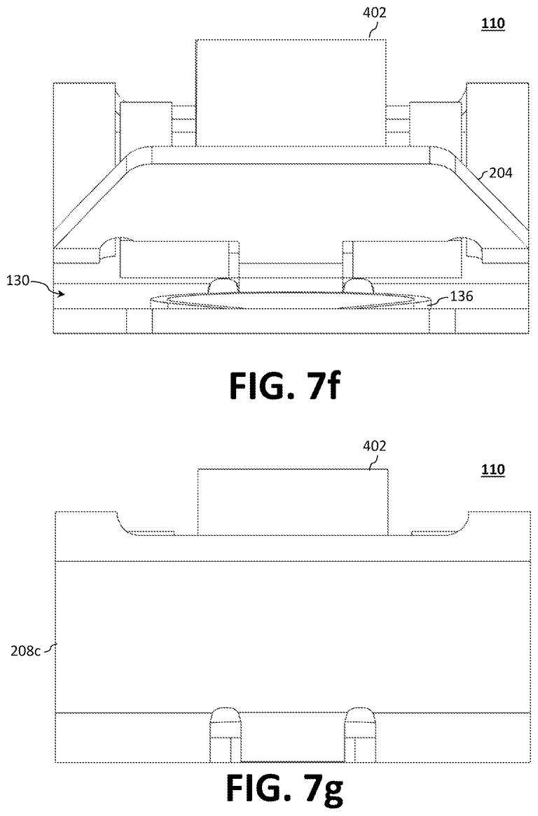

FIG. 7a illustrates a topside isometric view of a retainer clip 110 in accordance with yet another aspect of this disclosure. FIGS. 7b and 7c illustrate side elevation views of the retainer clip 110, while FIGS. 7d and 7e illustrate, respectively, top and bottom plan views of the retainer clip 110. FIGS. 7f and 7g illustrate, respectively, front and rear elevation views of the retainer clip 110. The retainer clip 110 of FIG. 7a through 7g is substantially similar to that of FIGS. 5a through 5g except for the configuration of the interlocking tabs 202a, 202b.

In the illustrated example, the set of first interlocking tabs 202a is coupled to the fastener plate 208d and a second interlocking tab 202b is formed at the bend 208c adjacent the second planar portion 208b. As best illustrated in FIGS. 7b and 7c, the set of first interlocking tabs 202a is positioned at an angle of about 135 degrees relative to the plane defined by the fastener plate 208d. Similarly, the second interlocking tab 202b is positioned at an angle of about 45 degrees relative to the planes defined by the second planar portion 208b and to the fastener plate 208d. As a result, the set of first interlocking tabs 202a and the second interlocking tab 202b are perpendicular to one another. In the illustrated example, the angle (α) defined between the guide lip 204 and the second planar portion 208b is about 45 degrees.

The retainer clip 110 further comprises a plurality of upturned tabs 702. In the illustrated example, the retainer clip 110 comprises four upturned tabs 702 positioned around the collar 402. Similar to the interlocking tabs 202a, 202b, the upturned tabs 702 serve to increase resistance to twisting of the under torque. In this case, the upturned tabs 702 are positioned between the flexible arms of the clip (i.e., the first planar portion 208a) to provide additional contact points when exposed to torque.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. An ergonomic retainer clip for attaching a first component having a first opening relative to a second component having a second opening, the ergonomic retainer clip comprising:
a first planar portion and a second planar portion that are resiliently connected via a bend to define a channel, wherein the second planar portion defines a fastener hole to receive a shank of a male fastener;
a fastener plate resiliently connected to the first planar portion and extending into the channel,
wherein the fastener plate is configured to couple with the male fastener, and
wherein the channel is configured to receive and secure the first component between the fastener plate and the second planar portion;
a guide lip positioned adjacent an opening to the channel and configured to guide the first component into the channel and to provide a bearing area for manipulation during assembly; and
a plurality of interlocking tabs configured to mitigate movement of the fastener plate relative to the first planar portion and the second planar portion.

2. The ergonomic retainer clip of claim 1, wherein the guide lip coupled to the first planar portion.

3. The ergonomic retainer clip of claim 1, wherein the fastener plate defines a head recess sized and shaped to receive a head of a male fastener.

4. The ergonomic retainer clip of claim 3, wherein the fastener plate comprises one or more retention features positioned at a perimeter of the head recess to retain and mitigate rotation of the male fastener relative to the fastener plate.

5. The ergonomic retainer clip of claim 4, wherein each of the one or more retention features comprises a retainer tab configured to retain the male fastener and a wall portion configured to mitigate rotation of the male fastener.

6. The ergonomic retainer clip of claim 1, wherein the fastener plate defines a collar with an internally-threaded bore that is configured to engage the shank of the male fastener.

7. The ergonomic retainer clip of claim 1, wherein the second planar portion comprises one or more panel tabs configured to secure the ergonomic retainer clip to the first component via an interference fit at the first opening.

8. The ergonomic retainer clip of claim 1, wherein the ergonomic retainer clip is a stamped-metal component.

9. The ergonomic retainer clip of claim 1, wherein the plurality of interlocking tabs comprises a set of first interlocking tabs coupled to the fastener plate interleaved with a second interlocking tab formed at the bend.

10. The ergonomic retainer clip of claim 9, wherein the second interlocking tab is formed at the bend adjacent the first planar portion.

11. The ergonomic retainer clip of claim 9, wherein the second interlocking tab is formed at the bend adjacent the second planar portion.

12. The ergonomic retainer clip of claim 9, wherein the set of first interlocking tabs is perpendicular to the second interlocking tab.

13. The ergonomic retainer clip of claim 7, wherein one of the one or more panel tabs is positioned in the fastener hole and configured to encircle the shank when assembled.

14. An ergonomic fastener assembly for attaching a first component having a first opening relative to a second component having a second opening, the ergonomic fastener assembly comprising:
a male fastener having a head and a shank; and
a retainer clip having a first planar portion and a second planar portion, fastener plate, and a guide lip,
wherein the first planar portion and the second planar portion are resiliently connected via a bend to define a channel,
wherein the fastener plate is resiliently connected to the first planar portion and extends into the channel and configured to couple with the male fastener, while the second planar portion defines a fastener hole to receive the shank,
wherein the channel is configured to receive and secure the first component between the fastener plate and the second planar portion, and
wherein the guide lip is positioned adjacent an opening to the channel and is configured to guide the first component into the channel and to provide a bearing area for manipulation during assembly.

15. The ergonomic fastener assembly of claim 14, wherein the retainer clip comprises a set of first interlocking tabs coupled to the fastener plate interleaved with a second interlocking tab formed at the bend to mitigate movement of the fastener plate relative to the first planar portion and the second planar portion.

16. The ergonomic fastener assembly of claim 14, wherein the fastener plate comprises one or more retention features, each of the one or more retention features comprising a retainer tab configured to retain the male fastener and a wall portion configured to mitigate rotation of the male fastener.

17. The ergonomic fastener assembly of claim 14, wherein the fastener plate defines a collar with an internally-threaded bore that is configured to engage the shank of the male fastener.

18. A stamped-metal ergonomic retainer clip for attaching a first component having a first opening relative to a second component having a second opening, the stamped-metal ergonomic retainer clip comprising:
a first planar portion and a second planar portion that are resiliently connected via a bend to define a channel, wherein the second planar portion defines a fastener hole to receive a shank of a male fastener;
a fastener plate resiliently connected to the first planar portion and extending into the channel,
wherein the fastener plate defines a collar with an internally-threaded bore that is configured to engage the shank of the male fastener, and
wherein the channel is configured to receive and secure the first component between the fastener plate and the second planar portion; and
a guide lip positioned adjacent an opening to the channel and configured to guide the first component into the channel and to provide a bearing area for manipulation during assembly.

19. The stamped-metal ergonomic retainer clip of claim 18, further comprising a set of first interlocking tabs coupled to the fastener plate interleaved with a second interlocking tab formed at the bend to mitigate movement of the fastener plate relative to the first planar portion and the second planar portion.

20. The stamped-metal ergonomic retainer clip of claim 18, wherein the second planar portion comprises one or more panel tabs configured to secure the stamped-metal ergonomic retainer clip to the first component via an interference fit at the first opening.
